(19) United States
(12) Patent Application Publication
(10) Pub. No.: US 2014/0083049 A1
(43) Pub. Date: Mar. 27, 2014

(54) SURFACE TEXTURE FOR MOLDED ARTICLES

(71) Applicant: MASONITE CORPORATION, Tampa, FL (US)

(72) Inventor: Mark RUGGIE, Kingston, IL (US)

(73) Assignee: MASONITE CORPORATION, Tampa, FL (US)

(21) Appl. No.: 14/034,168

(22) Filed: Sep. 23, 2013

Related U.S. Application Data
(60) Provisional application No. 61/704,011, filed on Sep. 21, 2012.

(51) Int. Cl. B44F 9/02; B29C 33/00; B29C 43/02; E06B 3/70

(52) U.S. Cl. CPC B44F 9/02; E06B 3/7001; B29C 33/00; B29C 43/02
USPC 52/784.1; 428/141; 428/151; 428/152; 249/187.1; 264/293

(57) ABSTRACT

A molded article integrates molded features that simulate an appearance of brush strokes. A die plate for forming the molded features simulating the brush strokes and a method of molding an article utilizing the die plate are also provided.

### CROSS-REFERENCE TO RELATED APPLICATION(S) AND CLAIM(S) OF PRIORITY

This application claims the benefit of priority of U.S. Provisional Application Ser. No. 61/704,011 filed Sep. 21, 2012, the complete disclosure of which is incorporated herein by reference and to which priority is claimed.

### FIELD OF THE INVENTION

The invention relates to molded articles having surface texture and method of making the same. In certain embodiments, the invention is directed to a textured door facing in which the texturing simulates the residue of paint left by a paint brush; i.e. texturing that simulates brush strokes. In particular, methods embodied herein permit texturing the surface of a polymer door facing to substantially reduce if not minimize the appearance of surface imperfections.

### BACKGROUND

Articles previously made of wood and other natural materials are increasingly being manufactured from molded composite components containing fiberglass and thermoset polymers. For example, exterior and interior doors for residential and commercial buildings, such as houses and office space, may be made from a fiberglass reinforced polymer composite material. Typically, composite door assemblies include a pair of compression molded exterior skins (also referred to herein and generally known as “facings”). The door skins are mounted on a rectangular frame, frequently formed of wood or metal, that separates and supports the skins in spaced relationship to one another. A space between the skins and bounded by the door frame typically is filled with an insulating core material, for example, cardboard, paper, fiberboard, or foam such as expanded polyurethane.

Composite door assemblies provide several advantages over natural wood and steel doors. Composite door assemblies resist rot and corrosion experienced with solid wood and metal doors, respectively. The composite door assemblies also generally are better insulators and easier to mold than solid wood and metal doors. Because of material costs and manufacturing efficiencies, composite door assemblies are considerably less expensive to manufacture than solid wood doors and can be designed to provide a reasonable facsimile of panels, horizontal planks (rail planks), vertical planks (stile planks), and wood grain on their outer surfaces.

A typical compression molding process used for making commercially available molded door skins involves placing a predetermined weight or volume of sheet molding compound (SMC) charge layer(s) containing a thermosetting polymeric material and reinforcement such as fiberglass on a lower mold half. An upper mold half is then advanced into juxtaposition with the lower mold half to force the SMC material to fill and to conform to the shape of the mold cavity during compression. The mold halves are heated to a processing temperature to facilitate flow of the SMC and cause the thermosetting reaction, also known as curing. Once solidified by curing, the molded door skins are removed from the mold press.

The upper mold half and the lower mold half have mold dies that form the mold cavity. The mold dies may have contours and embossments for shaping the SMC material during pressing. For example, the contours may shape the SMC material to make it appear that the door skin is a compilation of horizontal planks, vertical planks, and/or one or more interior door panels. Embossments may be used to imprint a wood grain pattern on the exterior surface of the molded door skin. Alternatively, the facings may be flush, that is, generally planar. The design flexibility of the molding process makes composite door assemblies useful for various residential and commercial buildings, as well as other uses.

The thermosetting resin system typically includes an unsaturated polyester resin and an unsaturated co-curable reactive monomer, such as styrene. The sheet molding compounds also contain a reinforcing agent, such as glass fibers, often present as chopped fiberglass and/or a thin fiber mat. Additives commonly combined with sheet molding compounds include catalysts, activating agents, thickening agents, stabilizers, and/or inert fillers such as calcium carbonate, talc, and/or cellulosic particles, such as wood particles and fibers.

As an alternative to molding, it is also known to print horizontal and vertical planks and interior panels on the exterior surfaces of door skins. However, the printed wood grain has no depth or texture, and therefore is a poor simulation for natural wood.

### SUMMARY

In accordance with an embodiment, a molded article is provided that includes an exterior surface integrating molded features that simulate a textural appearance of brush strokes of a paint brush.

In accordance with another embodiment, a door skin is provided that includes an exterior surface integrating molded features that simulate a textural appearance of brush strokes of a paint brush on a door.

In accordance with a further embodiment, a door is provided that includes a frame and a door skin. The door skin includes an interior surface secured to the door frame and an exterior surface integrating molded features that simulate a textural appearance of brush strokes remaining after application of paint by a paint brush.

Another embodiment includes a mold plate for forming a moldable material into an article, such as a door skin, having an exterior surface integrating molded features that simulate a textural appearance of brush strokes remaining after application of paint by a paint brush. The mold plate includes an etched surface configured to be pressed against the moldable material and to transfer molded features having the textural appearance of brush strokes remaining after application of paint by a paint brush to the material.

Another embodiment includes a method of molding an article. A molding compound is compressed against a plate under pressure to form a molded article having an exterior surface simulating a textural appearance of brush strokes remaining after application of paint by a paint brush. The plate includes a planar surface and a series of depressions extending into the planar surface. The depressions form ridges in the molded article simulating brush strokes.

Other embodiments, including apparatus, systems, methods, articles, products, and the like which constitute part of the invention, will become more apparent upon reading the following detailed description of the exemplary embodiments and viewing the drawings. It is to be understood that both the foregoing general description and the following detailed description are exemplary and explanatory only and therefore not necessarily restrictive.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. In such drawings:

FIG. 1 is a front elevation view of an exemplary door.

FIG. 2 is a perspective, sectional view of the door of FIG. 1 taken along line II-II of FIG. 1.

FIG. 3 is an exemplary brush stroke pattern.

FIG. 4 is an exemplary brush stroke pattern.

FIG. 5 is an exemplary brush stroke pattern.

FIG. 6 is an exemplary brush stroke pattern.

FIG. 7 is an exemplary brush stroke pattern.

FIG. 8 is an exemplary brush stroke pattern.

FIG. 9 is an exemplary brush stroke pattern.

FIG. 10 is a front elevational view of an exemplary door skin with a series of brush stroke pattern boxes.

### DETAILED DESCRIPTION OF EXEMPLARY EMBODIMENT(S) AND EXEMPLARY METHOD(S)

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods. For example, an apparatus and process is described below in connection with fiberglass reinforced polymer (FRP) doors and door skins formed of a composition including a thermoset binder in the form of a thermoset composition which is cured into the thermoset binder, and fiberglass being held together by the thermoset binder. However, the process may be used on a variety of articles, particularly door panels made from steel, wood, or wood composites, as well as door lites, side lites, window frames, panels and other building components.

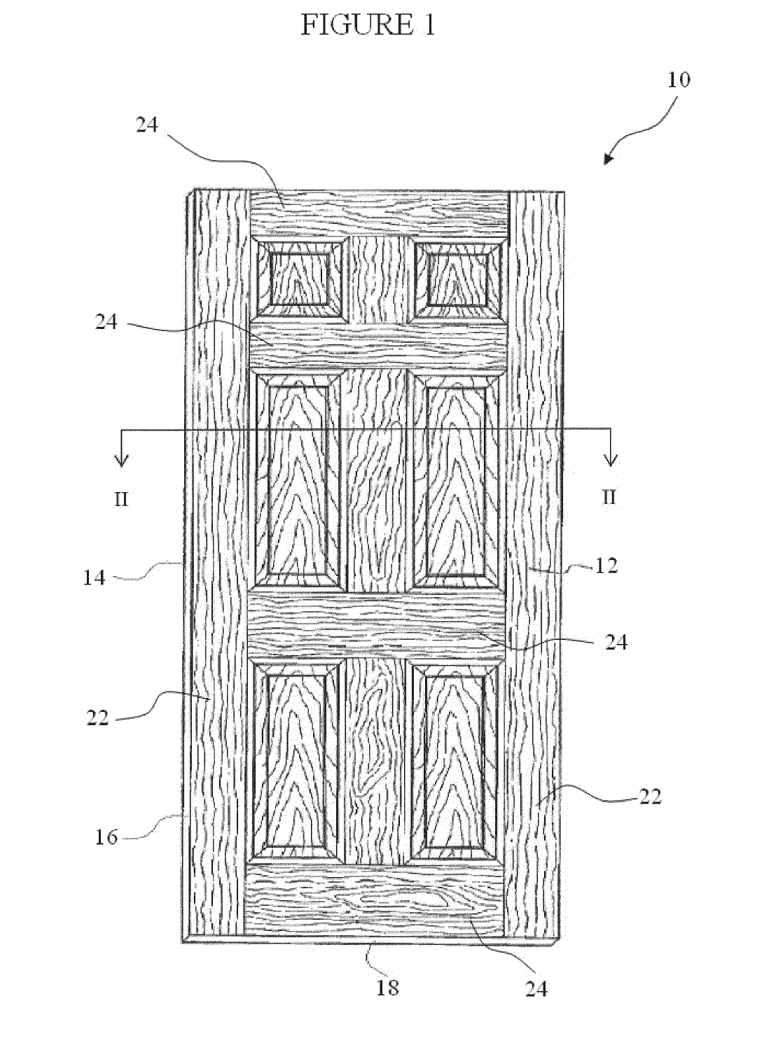

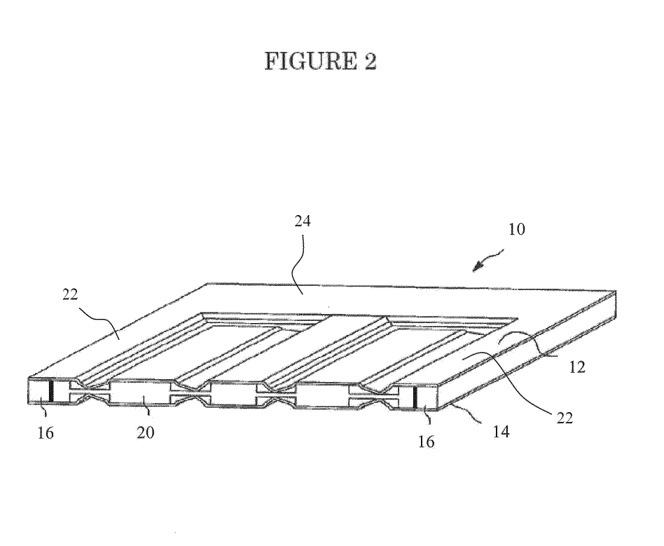

As best shown in FIGS. 1 and 2, a composite door assembly 10 has a multi-panel outer door skin (also referred to herein as facing) 12 and an inner door skin 14. The outer and inner door skins 12, 14 are substantially parallel to and spaced apart from one another. Although the door skins 12, 14 are shown as six-panel substantially rectangular door panels, it should be understood that the door skins 12, 14 may possess single-panel or alternative multi-panel designs, different shapes and configurations, and other appearances. Alternatively, the door skins 12, 14 may have the appearance of a flush door skin with no internal panels. The door skins 12 and 14 may be made from identical or different compositions, and may possess the same or difference appearance as one another.

The composite door assembly 10 may be an exterior entryway door or an interior passageway door of a building, such as a dwelling or commercial property. In view of the excellent thermal stability of the door skins and door assemblies described herein, use of the door assembly 10 as an exterior door is particularly advantageous. Exterior and passageway doors typically have a height of about 6 foot 8 inches to about 9 feet, more usually about 8 feet, and a width of about 3 to 4 feet, with 3 foot 6 inches being standard width for many passageway doors. Other uses of the composite door assembly 10 include furniture (e.g., cabinet, desk) drawers, furniture doors, and closet doors. Although not shown in the drawings, the composite door assembly 10 may include hardware, such as a handle, knob, or other grasping mechanism, with or without a locking mechanism. Although also not shown, openings may be provided in the door skins 12, 14 for receiving door lights (or “lites”) and other door components. The composite door assembly 10 may further include appropriate mounting hardware for its intended use, such as hinges for mounting the composite door assembly 10 to a wall structure (e.g., the frame of a door passageway) or guide rails for allowing sliding movement of the composite door assembly 10. While the embodiments described herein relate primarily to door skins and composite door structures, it should be understood that the disclosed invention may be more broadly applied for other composite panels.

Interior surfaces of the door skins 12, 14 are secured to opposite sides of an interior door frame using adhesive, fasteners, other conventional fastening devices and techniques, or a combination thereof. Although not intended to be limiting, the door frame is typically made of wood but sometimes is made of composite materials, man-made pressed wood, wood composites, metals, or a combination of these and/or other materials. The door frame includes vertical members known as stiles 16 positioned at opposite sides of the door 10 and extending vertically along substantially the entire length of the door 10. The frame further includes horizontal members known as rails 18 positioned at opposite (top and bottom) ends of the door 10 and extending horizontally along substantially the entire width of the door 10. The stiles 16 and rails 18 collectively establish the periphery of the door 10 in the illustrated embodiment. Although not shown, the frame may include intermediate stiles and/or rails hidden from view between the door skins 12, 14. The door skins 12, 14 may have strike lines that demarcate the substantially planar exterior surface areas of the door skins 12, 14 into vertical sections on the outer sides referred to as stile planks 22 extending over the frame stiles 16 and horizontal sections referred to as rail planks 24 extending over the frame rails 18.

The exterior surfaces of the door skins 12, 14 may simulate a smooth surface or textured grain, or a combination thereof. The texture may simulate that of a wood grain design as shown in FIG. 1, or other designs. As best shown in FIG. 1, the rail planks 24 have a substantially horizontal wood grain, whereas the remainder of the exterior surface, including the stile planks 22, has a substantially vertical wood grain. The different directions of the wood grain assist in simulating the appearance of a door that is formed of multiple natural wood planks, even though the composite door 10 shown in FIG. 1 is formed of a single molded piece.

The coloration of the door skins 12, 14 is often a wood toned color, although any base coloration may be used. Stain, paint, pigments, or other colorant may be applied to the door skins 12, 14, as may print ink grain designs and the like. Alternatively, an image can be printed on the exterior surfaces of the door skins 12, 14, as described in U.S. Pat. No. 7,001,016. The aesthetic appearance and tactile feel of the door skins 12, 14 may be substantially identical to or different from one another. The tactile feel may also resemble that of a door made from real wood. The exterior surfaces of the door skins 12, 14 optionally may be sealed. Optionally, a veneer may be bonded to portions of the exterior surfaces to provide a desired appearance (e.g., decoration, color, grain and/or inlay patterns of natural wood).

As best shown in FIG. 2, a core component 20 is optionally situated between the outer and inner door skins 12, 14. As referred to herein, the term “composite door assembly” encompasses within its meaning a door shell (i.e., the frame and door facings 12, 14) with or without the core component 20. The core component 20 may comprise a foam formed of any suitable polymer material which can be injected and formed in place (in situ) between the door skins 12, 14 and the frame, or can be pre-formed and then placed in the frame prior to attachment of one or both of the door skins 12, 14 to the frame. Non-foam materials that may be used include, for example, corrugated pads and other insulation and materials. It should be noted that the interior surfaces of the door skins 12, 14 may be adhered to the core component 20, if present. Optionally, the door assembly 10 may exclude a core, e.g., to provide an empty hollow area between the door skins 12, 14.

The door skins 12, 14 may be made of various resins systems and additives, including those materials commonly employed in the door-fabrication industry. According to an exemplary embodiment, the door skins 12, 14 are made of a thermosetting resin composition (or thermoset composition cured into a thermoset binder holding together fibers such as fiberglass), preferably a sheet molding compound (SMC) or bulk molding compound (BMC) composition. The thermosetting composition preferably contains at least one unsaturated polyester resin and at least one unsaturated, co-curable crosslinking monomer such as styrene that is reactive with the polyester. The unsaturated polyester resin may comprise a polycondensation reaction product of one or more dihydric alcohols and one or more unsaturated polycarboxylic acids. A heat-activated catalyst may be included in the composition. Another example of a suitable thermosetting resin is a polyurethane resin, such as a urethane sheet molding compound, which may comprise, for example, a urethane polymer or prepolymer, a crosslinker and/or linking agent, such as a di- or polyisocyanate, and a catalyst. Other thermosetting resin systems can be used in addition to or as alternatives for the unsaturated polyester, such as phenolic resins, vinyl ester resins, and epoxy resins. Additionally, the resin component of the composition may include one or more thermoplastic polymers, for example, polyolefins such as polyethylene, polypropylene, polystyrene, acrylonitrile-butadiene-styrene (ABS), acrylate-styrene-acrylonitrile (ASA), and others.

The composition may include low shrinkage and low profile additives, organic initiators (e.g., tertiary-butyl peroxybenzoate), thickening agents (e.g., oxides, hydroxides, and alcoholates of magnesium, calcium, aluminum), stabilizers, inhibitors, fillers, reinforcements, nanocomponents (see U.S. Pat. Appln. Pub. No. 2008/0016819 to Xu et al., “Nano-composite door facings, and related door assemblies and methods”), and other additives. Examples of low profile additives include thermoplastic polymers, such as saturated polyesters, polystyrene, polyvinyl acetate, and copolymers and terpolymers of the same. Other low profile additives known in the art may also be included.

The glass fibers may be either treated or untreated. The fibers may have a length in a range of, for example, about 3 mm to about 7.62 cm (about 3.0 inches). In the case of fiberglass, for example, the glass may be blended into the composition, and chopped into fibers of variable length during an extrusion process. Alternatively, the fibers may have a substantially uniform length. Pre-chopped glass fibers may also be used. The chopped fibers may be mixed into the composition during blending. Fiberglass is often found in many commercial sheet molding compounds, and often is present as 1 inch or half inch chopped fiberglass.

Fillers and reinforcements may be incorporated to serve various purposes, including extending the resin, improving mold flow, and/or imparting desired characteristics and mechanical properties to the finished product. Examples of other fillers that may be included in the composition are calcium carbonate, clay, graphite, magnesium carbonate, talc, and mica, including muscovite mica or phlogopite mica. It is often desirable from a cost-savings standpoint to incorporate at least as much mica as fiberglass into the composition.

Additional examples of fillers and reinforcements include graphite, aramids, and organic fibrous additives, in particular cellulosic materials. Suitable organic fibrous additives include wood powder or wood flour, such as provided by relatively small particles of pine and other suitable wood, such as oak, cherry, maple, gum and combinations of the same or other woods. Other fibrous organic materials may also be used, including but not limited to cellulosic materials such as straw, rice husks, and kenaf. The organic fibrous additive component may comprise a mixture of wood and other fibrous organic materials. The additive may be sized to pass through an 80 mesh sieve, although different sizes may be used. The organic fibrous material may be a by-product of other wood manufacturing processes. For example, the organic fibrous material may be considered to be part of the waste stream of a manufacturing facility. Use of waste material has significant cost and environmental benefits. The filler and reinforcement materials may take various physical shapes, such as fibrous, microspheres, or one or more mats.

The SMC/BMC composition may be embodied to constitute, for example, about 15 to about 25 weight percent of the thermosetting resin composition, about 10 to about 20 weight percent low profile additive, about 13 to about 20 weight percent reinforcement, and about 30 to about 50 weight percent filler, and optionally other ingredients, such as, for example, mold release agents, shelf inhibitors, wetting agents, homogenizers, UV retardants, pigments, fire retardants, thickening agents, antioxidants, antistatic metals, colorants, and other additives. Concentrations may be adjusted as warranted for obtaining desired properties.

Any suitable molding technique may be employed for compressing and shaping door skins 12, 14, including, for example, compression molding, resin transfer molding, injection compression molding, thermoforming, and injection molding. Generally, compression molding involves introducing the pre-blend and/or unblended components onto a lower die, the moving one or both dies towards the other to form a closed cavity. The dies may possess embossing structures/surfaces with texture designed to transfer embossments and grain to the molded article, e.g., door skin. During pressing, the components are pressed together between the upper and lower dies and shaped by application of heat and pressure. Sheet molding compounds are often pressed within a temperature range of about 135° C. (275° F.) to about 177° C. (350° F.), often about 138° C. (280° F.) to about 160° C. (320° F.), although temperatures will depend on the composition of the sheet/bulk molding compound. The dies may exert a pressure on the composition of, for example, about 1000 psi to about 2000 psi, although lower or higher pressures may be used. The pressing operation often lasts, for example, about 30 seconds to 2 minutes.

In various exemplary embodiments, a molded article such as a door skin 12 may be molded to have a brush-stroke painted textual appearance incorporated into the exterior surface of the door skin 12 without actual application of paint. A door skin 12 is molded to have a textured surface which simulates or mimics the texture of brush strokes that remain after application of a finishing coating, for example paint, with a tufted or bristle brush.

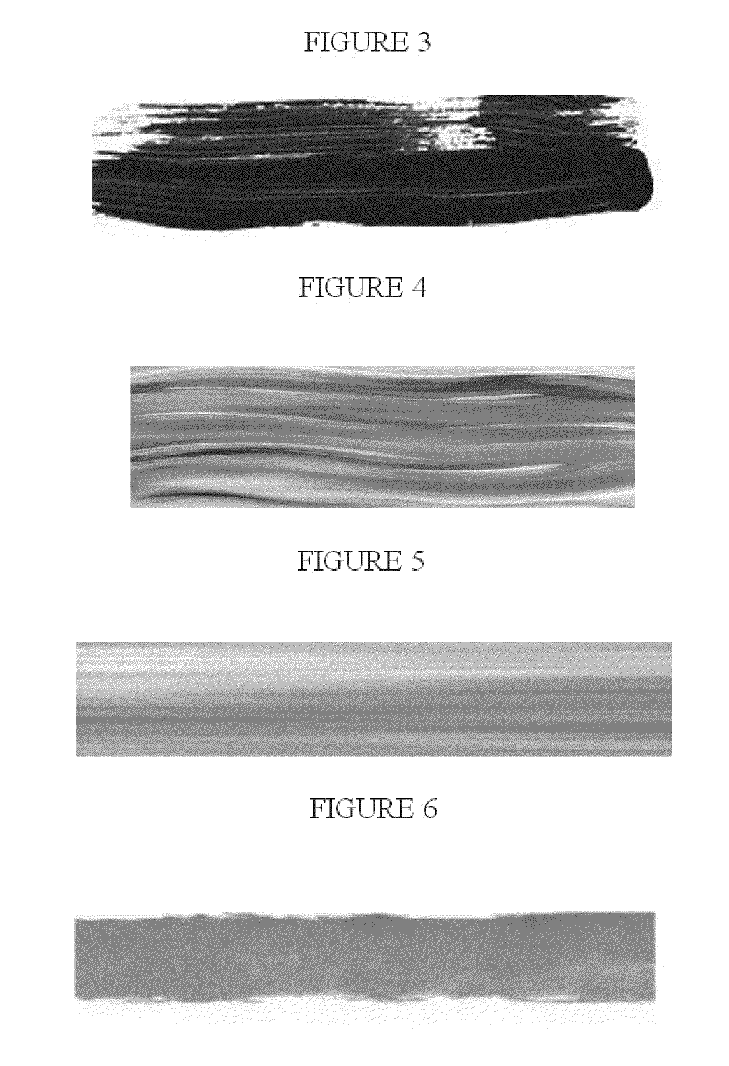

FIGS. 3-9 depict various types of painted brush strokes. FIGS. 3-9 each show horizontal brush strokes, which may be present, for example, on portions of the door skin corresponding to the horizontal planks. The brush strokes may be vertically oriented, for example, as they would appear on a portion of the door skin corresponding to vertical planks. The embodiments shown in FIGS. 3-9 represent different thickness brush bristles and different patterns. Paint brush bristles typically have a diameter of between about 0.08 and about 0.15 mm and sometimes even up to about 0.2 mm. To simulate the brush strokes, the door skin 12 may be molded to have ridges which are slightly raised above a principal planar surface, forming a textured surface similar to and simulating the texture of the brush strokes shown in FIGS. 3-9. The raised ridges and grooves simulate the brush stroke pattern formed by the bristles.

The brush strokes may be oriented substantially parallel with one another in a vertical direction, a horizontal direction, an angled fashion, or any combination thereof. For example, the door skin 12 may have molded features simulating vertical brush strokes which run along the length of the stile planks 22 in the direction of the grain (e.g., from top to bottom of the stile planks 22 in FIG. 1) and other molded features simulating horizontal brush strokes running along the width of the rail planks 24 in the direction of the grain (e.g., from left to right in FIG. 1). The bristles of a paint brush typically are of the same material and thus have substantially the same diameter, and thus the brush strokes simulated in the invention thus typically have substantially the same dimension protruding outwardly from the surface of the door facing. It will be appreciated that while the simulated brush strokes have substantially the same diameter, typically less than the entire diameter will protrude outwardly from the door facing. Hence, while the diameter of any individual bristle may be, for example, about 0.08 mm to about 0.15 mm, the bristle will protrude about 0.04 mm to about 0.075 mm from the door facing.

A molded, textured surface pattern mimicking the texture of painted brush strokes can enhance the aesthetic appearance of the door and aid in finishing processes. By molding the painted brush strokes directly into the door skin as integral components, paint, stain, or other colorant or finish may be applied to the exterior surface in a more efficient method, e.g., by spraying, to provide the desired paint-brush texture without requiring the time-consuming task of actually brushing the door with a paint brush. Moreover, a finishing coating, for example varnish or a sealant, may be applied over the molded brush strokes which can provide a further desired appearance or characteristic while shortening the process time.

Simulated brush strokes may incorporate a variety of design features. For example, each brush stroke may include opposing side walls extending out of a principal planar surface, thereby forming ridges that may be parallel to one another with grooves or depressions between the ridges. The ridges and grooves correspond to and simulate areas of the principal planar surface that are contacted with paint on the bristles and areas between the bristles of the paint brush. The height of the ridges relative to the depth of the grooves may be selected to reflect bristle length and density. The side walls of the ridges may taper towards each other as they extend away from the principal planar surface. In certain sections the brush strokes may taper to a point or form a plateau. The brush strokes may have straight portions simulating long steady paint-brush strokes and curvilinear portions simulate the ends of the paint-brush strokes or shorter random strokes. For example, the brush strokes may have a straight lines intermittent with slight curves or wavy lines, depicting the natural movement of individual bristles of a paint brush. Larger curves or wavy lines may simulate deviation of the hand controlling the paint brush from a straight line. For example, in the drawings, FIG. 3 simulates a paint stroke with a brush lacking sufficient paint to completely form the upper half of the paint stroke. FIG. 4 shows a relatively wavy brush stroke, while FIG. 5 shows a much more linear paint stroke. FIG. 6 shows a paint stroke made with fine bristles.

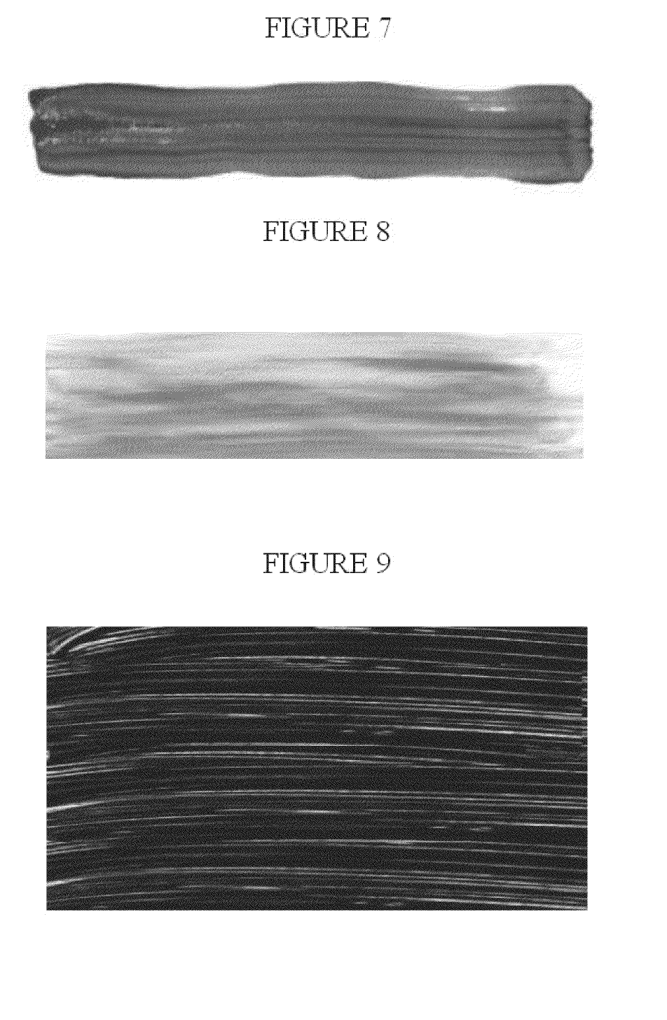

FIGS. 7 through 9 depict paint strokes of different brush densities. In FIG. 9 in particular, the brush strokes are seen as slightly curved, especially near the upper left corner of the drawing, thereby simulating the irregularity of manual brush strokes performed by hand instead of machine. The amount and frequency of the curved portions may be controlled to give a randomized, and thus more natural, appearance. The depth individual strokes may vary to represent longer or shorter bristles. The width of individual strokes may vary to represent coarser or finer bristles. Different combinations of the above-mentioned design features may be combined in any manner to form a realistic pattern. The pattern may mimic any applied finish, such as paint, stain, lacquer, varnish, sealant, and shellac.

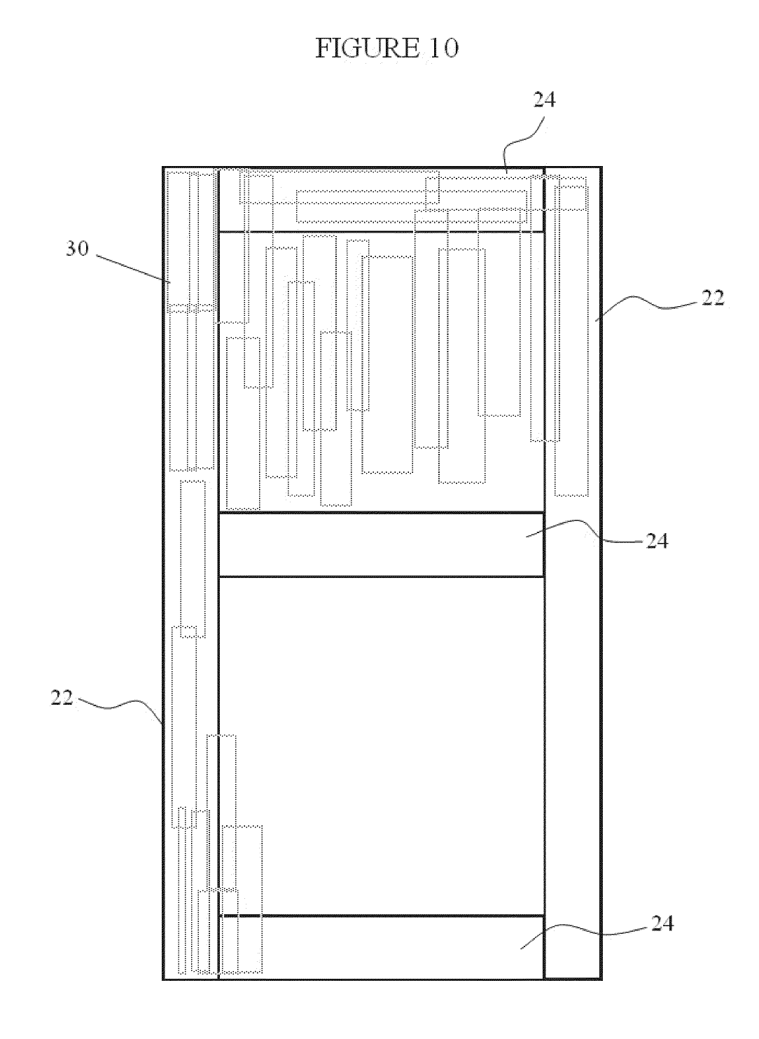

The length, width, depth and position of the brush strokes may also be controlled to give the appearance of repeating and overlapping brush strokes found in typical finishing applications such as painting by hand. For example, where the outer door surface is intended to give the appearance of overlapping brush strokes, the ridges and depressions may be slightly raised relative to other simulated non-overlapping brush strokes to simulate multiple coatings. As shown in FIG. 10, the pattern blocks 30 (depicted as a rectangular blocks in dashed lines) may represent a grouped pattern of brush strokes. The pattern block 30, or other similar patterns, may then be placed in an overlapping fashion, in both horizontal and vertical directions, to give the appearance of the start and stop positions of natural brush strokes. In this way the simulated brush strokes can extend across the ovalo that separates the panel from the stile plank or rail plank. Each pattern block 30 may be of an identical size, shape, and internal pattern, or the size, shape, and internal pattern may vary from pattern block 30 to pattern block 30. As shown in FIG. 10, the pattern blocks 30 may overlap across divisions (also known as strike lines) of the stile planks 22 and rail planks 24.

The simulated brush strokes may be molded directly into the surface of the door facing using a plate, such as an embossing plate or a mold plate. Other methods of forming the simulated brush strokes may include machining, laser etching, or other processes known in the art. In various exemplary embodiments utilizing a method of molding, a die plate has a principal planar surface into which grooves may extend into and/or from which ridges may extend out of relative to the planar sections. When the plate is pressed into the surface of a material, such as the sheet molding compounds during shaping and curing as discussed above, the grooves in the mold plate will form corresponding raised textured surface features simulating the texture of paint brush strokes, while the ridges will form corresponding indented textured surface features simulating the texture of paint strokes and/or a paint-covered wood grain pattern. The grooves and ridges may have variable widths, depths, and lengths and include any of the design features discussed above.

The mold plate may be formed through etching, for example chemical etching utilizing a resist. A brush stroke pattern may initially be obtained. The brush stroke pattern may mimic a desired brush size, bristle size, coating type, stroke direction, or any combination thereof. In an exemplary embodiment, the brush stroke pattern may be taken from an image of a painted door. One or more images may be used and digitally “assembled” to create a complete molded article, for example an image of a door, a panel, or the like. As shown in FIG. 10, an individual image such as the pattern block 30 may be repeated and layered over the entire exterior surface of the article. The final image forms the layout image for the molded article.

The image or images also may be enhanced by increasing the resolution or adjusting the size of the image. Specifically, the size of the image may be increased, for example by about 300%. Resolution of the image is then increased, for example from about 600 dpi to about 2400 dpi. In this way, the brush stroke pattern may be easily adjusted and spaced in the image to avoid etching lines that are too close to each other.

The resulting layout image may be enhanced and separated by computer software, such as available with Photoshop™ into a series of layers. Each layering image corresponds to an etching cycle. Thus, the more layering images that are used, the more etching cycles the plate undergoes. The number of layers may be selected by a user or determined automatically by a computer. For example, each layering image is an image of the resulting ridges and/or depressions formed on the article. The height of the ridges as well as the depth of the depressions may be adjusted by a user or determined automatically by a computer program, which correlates the shades and colorations of ridges and depressions in the initial layout image to corresponding heights/depths. For example, the highest ridges may have the darkest, widest appearance in the initial image and are formed having the greatest height relative to a base planar region. Ranges for the height and depth may vary depending on the substrate being molded and the brush stroke pattern. The layering of the image allows a pattern to be gradually etched into a plate.

The plate may be formed from any suitable metal, for example copper, such as 20 gauge copper, aluminum, cold rolled steel, SP300 steel, or stainless steel. Prior to etching, the plate is thoroughly cleaned. Then, a first resist coating is applied to the surface of the plate. The resist may be a lacquer-based resist, such as that used by Wood Graphics of Cincinnati, Ohio. The resist is sprayed onto the surface of the plate to a thickness of about 4-6 microns. After the plate has been prepared with the resist, an image corresponding to the first layering image is laser ablated into the resist. The first layered image forms the highest ridges or deepest depressions. The resist may be precisely removed using the laser. Alternatively, the image may be developed into a photo sensitized lithography plate to be used as a pattern master to create a resist, for example from a wax based material.

The coated plate is then etched with acid. Preferably, a ferric chloride based acid is sprayed onto the surface of the plate. It should be noted, however, that the type of acid used varies depending on the type of metal being etched. A first level of etching eats into the surface of the plate to a depth of about 0.004 inches. As known in the art, the amount of time required for acid etching is a function of depth desired, as well as the strength of acid used. After the first etching cycle is complete, the plate is thoroughly cleaned with an alcohol-based cleaner to remove any remaining resist or etching residue. The plate may then be subjected to an acid bath. Preferably, a ferric chloride based acid is used, as used in for the first etching cycle. The acid bath rounds off any sharp edges formed during the first level of etching. Preferably, any sharp edges are rounded down (i.e., eaten away by the acid) by about 0.001 inches. The plate is then washed to remove any acid and/or particulates. This process is repeated in a number of cycles dependent on the number of image layers. An exemplary process for forming the etched plate is found in U.S. Pat. No. 6,988,342, the disclosure of which is incorporated herein by reference.

The door skin 12 may also have a naturally appearing wood grain pattern formed in an exterior surface. The wood grain pattern may include ticks (wood grain lines), knots and background tonal variations. The wood grain combines with the brush stroke pattern to give the appearance of a painted wooden door. As with the simulated brush strokes, the wood grain pattern may be formed using an etched plate, such as in an embossing plate or molded die set, or other processes known in the art. The wood grain pattern may contain grain lines, ticks, and tonal portions. Forming wood grain patterns into a composite door facing is taught by U.S. Pat. Nos. 6,988,342 and 7,367,166. The wood grain pattern may be formed prior to, subsequent to, or simultaneously with the brush stroke pattern. The wood grain pattern and brush stroke patterns may be formed into the same plate. For example, using a photographic image of a painted wood grain surface, computer software such as available with Photoshop™ and etching techniques may be used to make an embossing plate that accentuates brush strokes over bundles of wood ticks that form the wood grain pattern.

Those skilled in the art recognize that molding with SMC frequently results in minor surface imperfections or some lack of uniformity in surface appearance that is visually apparent. Consumers wish that the door being acquired has a uniform appearance, so that any surface appearance discontinuities are undesirable. The simulated brush strokes of embodiments of the invention described herein more accurately simulate a real brush-painted surface and those simulated brush strokes also mask or interrupt any surface discontinuities. Thus surfaces discontinuities that might otherwise be apparent are either eliminated or are sufficiently masked so as to not create an appearance of a defect to a consumer. The invention as embodied in this detailed description therefore results in a surface appearance that more accurately represents a brush-painted door, enhancing the consumer experience, while masking surface discontinuities that could result in rejects so that costs are correspondingly decreased.

While the exemplary embodiments described herein are directed to doors and door skins, it should be understood that the present invention is applicable to a wide range of molded and/or embossed articles, such as door lites, side lites, cabinet doors, furniture doors, millwork, wainscot, paneling, construction components, decorative moldings, trim products, flooring products, and the like.

Moreover, the exemplary embodiments described herein are directed to molded articles formed from polymer-based composites, such as sheet molding compound (“SMC”), other substrates may be molded, pressed or embossed, including medium density fiberboard, hardboard, fiberboard, steel, other wood composite materials, and other thermoplastic materials.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the precise embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

Only those claims which use the words “means for” are intended to be interpreted under 35 U.S.C. §112(f).

What is claimed:

1. A molded article comprising an exterior surface integrating molded features that simulate a textural appearance of brush strokes.

2. The molded article of claim 1, wherein the molded features comprise molded ridges generally aligned with one another to simulate the textural appearance of brush strokes.

3. The molded article of claim 2, wherein the molded features further comprise molded grooves between the molded ridges.

4. The molded article of claim 2, wherein the exterior surface further integrates additional molded wood ticks that simulate a textural appearance of wood grain.

5. The molded article of claim 2, wherein the molded ridges comprise linear portions.

6. The molded article of claim 2, wherein the molded ridges comprise curvilinear portions.

7. The molded article of claim 2, wherein the molded ridges taper.

8. The molded article of claim 1, wherein the molded features simulate a textural appearance of overlapping brush strokes.

9. The molded article of claim 2, wherein the molded article comprises a door skin, a door lite, a side lite, a cabinet door, a furniture door, millwork, wainscot, paneling, a construction component, a decorative molding, a trim product, or a flooring product.

10. The molded article of claim 2, wherein the molded article comprises a thermoplastic material or a wood composite.

11. The molded article of claim 2, wherein the molded article comprises a sheet molding compound, medium density fiberboard, hardboard, or fiberboard.

12. The molded article of claim 2, wherein the ridges have a thickness in a range of about 0.08 mm to about 0.15 mm.

13. The molded article of claim 12, wherein the ridges have a height in a range of about 0.04 mm to about 0.075 mm.

14. A door skin comprising an exterior surface integrating molded features that simulate a textural appearance of brush strokes on a door.

15. The door skin of claim 14, wherein the molded features comprise molded ridges generally aligned with one another to simulate the textural appearance of brush strokes.

16. The door skin of claim 15, wherein the molded features further comprise molded grooves between the molded ridges.

17. The door skin of claim 15, wherein the molded ridges comprise curvilinear sections.

18. The door skin of claim 15, wherein the molded ridges vary in length.

19. The door skin of claim 14, wherein the molded features simulate an appearance of overlapping brush strokes.

20. The door skin of claim 14, wherein the molded features simulate a textural appearance of horizontal brush strokes.

21. The door skin of claim 15, wherein the ridges have a thickness in a range of about of about 0.08 mm to about 0.15 mm.

22. The door skin of claim 21, wherein the ridges have a height in a range of about 0.04 mm to about 0.15 mm.

23. A door comprising:
a frame; and
the door skin of claim 14, the door skin having an interior surface secured to the frame.

24. A mold plate for forming a surface pattern in a material, the mold plate comprising:
an etched surface configured to be pressed against a moldable material to transfer mold features to the moldable material, the mold features comprising a textural appearance of brush strokes.

25. A method of molding an article comprising:
compressing a molding compound in a mold cavity against a plate under pressure to form a molded article integrating molded features that simulate a textural appearance of brush strokes, wherein the plate comprises the mold plate of claim 24.
